(19) United States
(12) Patent Application Publication
(10) Pub. No.: US 2004/0039721 A1
(43) Pub. Date: Feb. 26, 2004

(54) Folder information notifying system and method therefor

(75) Inventor: Hiroteru Tsuchiya, Numazu-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/224,357

(22) Filed: Aug. 21, 2002

(51) Int. Cl. G06F 7/00

(52) U.S. Cl. 707/1

(57) ABSTRACT

To provide a folder information notifying system and a method therefor that enable a user terminal to detect the presence of a folder in an information storage device newly installed on a LAN. In a system including a plurality of file information storage devices and a plurality of user terminals that are interconnected via a network and accessible to a file document stored in a folder in the file information storage devices, the method includes the steps on the side of the file information storage device including a step S51 of creating a shared folder, a service information generating step S52 of generating service information from an identifier of the created shared folder and an identifier of the file information storage device, and a notifying step S53 of notifying the network of the service information, and the steps on the side of said user terminals including a service information analyzing step of analyzing the service information provided to the network, and a displaying step of displaying the analyzed service information.

### BACKGROUND OF THE INVENTION

1. Field of the Invention

The present invention relates to a folder information notifying system for notifying a user terminal of folder information registered with file information storage devices sharing file information via a network, such as a multi function printer (multi-function peripheral: MFP) terminal and a filer server.

2. Description of the Related Art

Network systems adapted so that a plurality of user terminals share information registered with information storage devices which share the information via the network, such as a MFP terminal and a file server, are disclosed in Japanese Patent Laid-Open Nos. 10-42115, 2000-353172 and 11-338658, for example.

In these conventional network systems, when a user is to retrieve a document in a MFP terminal or file server connected to a concerned LAN (local area network), if the MFP terminal or file server is a type of device to successively accumulate document information in a folder therein, the user is required to operate a computer to access the folder when he/she is not busy, check for a new document, and if any new document is found, determine whether it is a concerned one or not. Besides, if a new MFP terminal or file server for storing document information is installed on the network, the user is required to be informed of the installation and location thereof by an administrator and to check the new device for a concerned document.

However, when a new MFP terminal or file server for storing document information is installed, the administrator often fails to inform the user of the installation or the user often fails to receive the information, resulting in inadequate information recognition.

In addition, in the past, the user has been required to manipulate the folder to check it for a new file document, and in particular, when a plurality of information storage devices each have a plurality of folders, the checking needs much time and effort.

### SUMMARY OF THE INVENTION

The present invention has been devised in view of the circumstances described above. An object of this invention is to provide a folder information notifying system and a method therefor, in which when an information storage device storing document information in a folder, such as a MFP terminal and a file server, is newly installed on a LAN, if an administrator fails to inform a user of the installation or the user fails to receive the information, the presence of the folder in the information storage device can be automatically known to the user terminal. In addition, an object of this invention is to provide a folder information notifying system and a method therefor that can save the user terminal on the LAN from having to retrieve a concerned document.

In order to attain the objects, a folder information notifying system according to this invention comprises a plurality of file information storage devices for storing a document interconnected via a network, and a plurality of user terminals that are interconnected via the network and accessible to a file document stored in a folder in the file information storage devices, in which each of the file information storage device comprises a shared folder creator unit for creating a shared folder, a service information generator unit for generating service information from an identifier of the created shared folder and an identifier of the file information storage device, and a notifying unit for notifying the network of the service information, and each of the user terminals comprises a service information analyzer unit for analyzing the service information provided to the network, and a display unit for displaying the analyzed service information. According to this configuration, when the file information storage device storing document information in a folder, such as a MFP terminal and a file server, is newly installed on the LAN, if the administrator fails to inform the user of the installation or the user fails to receive the information, the user terminal is notified of the service information when the shared folder is created, and thus, the presence thereof can be automatically known to the user.

In addition, when a document to be opened is stored in the shared folder, the service information generator unit in the file information storage device generates the service information with a document name stored in the shared folder in addition to the identifier of the shared folder and the identifier of the file information storage device. According to this configuration, the user terminal is notified of the service information with the document name stored in the shared folder, and therefore, it is possible to save the user terminal on the LAN from having to retrieve a concerned document.

Besides, in a system comprising a plurality of file information storage devices for storing a document interconnected via a network and a plurality of user terminals that are interconnected via the network and accessible to a file document stored in a folder in the file information storage devices, a folder information notifying method for notifying a user terminal of folder information according to this invention comprises the steps on the side of the file information storage device including a shared folder creating step of creating a shared folder, a service information generating step of generating service information from an identifier of the created shared folder and an identifier of the file information storage device, and a notifying step of notifying the network of the service information, and the steps on the side of the user terminals including a service information analyzing step of analyzing the service information provided to the network, and a displaying step of displaying the analyzed service information. According to this configuration, when the file information storage device storing document information in a folder, such as a MFP terminal and a file server, is newly installed on the LAN, if the administrator fails to inform the user of the installation or the user fails to receive the information, the user terminal is notified of the service information when the shared folder is created, and thus, the presence thereof can be automatically known to the user.

In addition, the service information generating step on the side of the file information storage device is to generate, when a document to be opened is stored in the shared folder, the service information with a document name stored in the shared folder in addition to the identifier of the shared folder and the identifier of the file information storage device. According to this configuration, the user terminal is notified of the service information with the document name stored in the shared folder, and therefore, it is possible to save the user terminal on the LAN from having to retrieve a concerned document.

### DESCRIPTION OF THE DRAWINGS

FIG. 1 is a block diagram showing a system configuration of a folder information notifying system according to this invention;

FIG. 2 is a block diagram illustrating an internal function of file information storage devices 1A, 1B and 1C shown in FIG. 1 according to an embodiment 1;

FIG. 3 is a block diagram illustrating an internal function of computers 2A, 2B and 2C shown in FIG. 1 according to the embodiment 1;

FIG. 4 illustrates one example of folder service information generated by a document storage area information generator unit 1d in a file information storage device 1 shown in FIG. 2;

FIG. 5 is a flowchart illustrating a series of processings performed when a shared folder is created in the file information storage device 1 shown in FIG. 2;

FIG. 6 is a flowchart illustrating a series of processings for a module in the computer 2 shown in FIG. 2 to detect XML data, which is the folder service information provided to the network;

FIG. 7 is a block diagram illustrating an internal configuration of file information storage devices 1A, 1B and 1C shown in FIG. 1 according to an embodiment 2;

FIG. 8 is a block diagram illustrating an internal configuration of computers 2A, 2B and 2C shown in FIG. 1 according to the embodiment 2;

FIG. 9 illustrates one example of document service information generated by a document information generator unit if in the file information storage device 1 shown in FIG. 7;

FIG. 10 is a flow chart illustrating a series of processings performed when the file information storage device 1 shown in FIG. 7 stores a document in the shared folder; and

FIG. 11 is a flow chart illustrating a series of processings for a module in the computer 2 shown in FIG. 8 to detect XML data, which is the document service information provided to the network.

### DESCRIPTION OF THE PREFERRED EMBODIMENTS

Now, embodiments of this invention will be described with reference to the drawings.

Embodiment 1

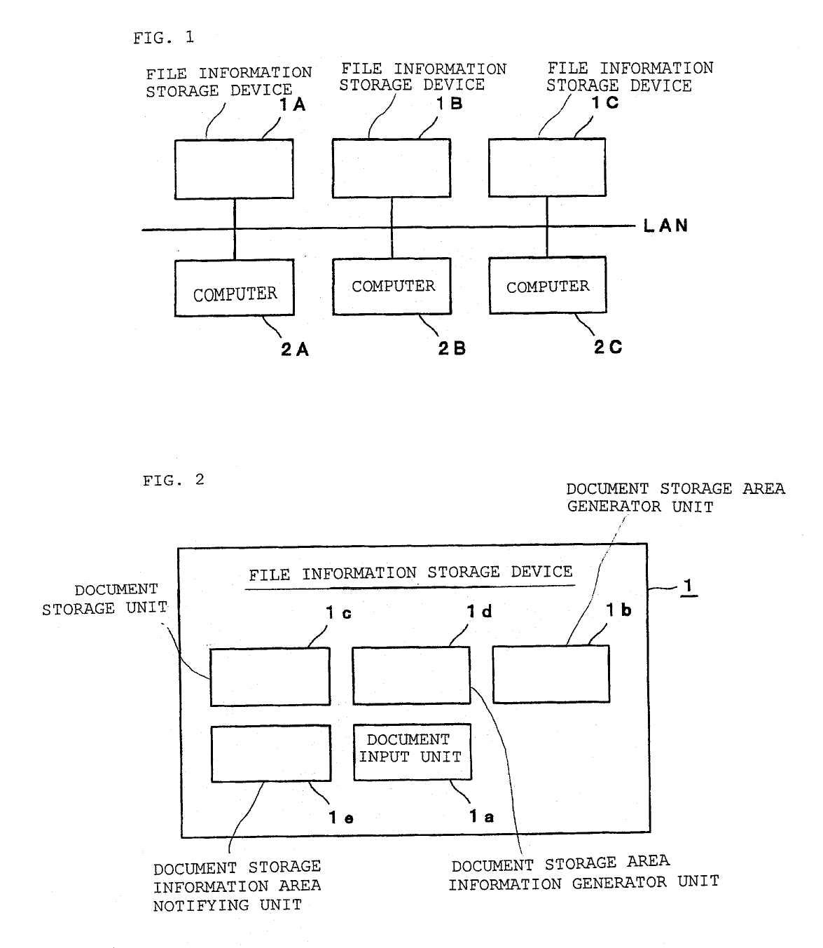

FIG. 1 is a block diagram showing a configuration of a folder information notifying system according to this invention. As shown in FIG. 1, as a file information storage device for storing document information in a shared folder, such as a MFP terminal or file server, file information storage devices 1A, 1B and 1C are connected to a LAN, and a folder capable of accumulating documents therein can be created in each of the file information storage devices. In addition, computers 2A, 2B and 2C serving as terminal devices are connected to the LAN, and an operator of each of the computers can access a shared folder on any file information storage device to edit a document in the shared folder.

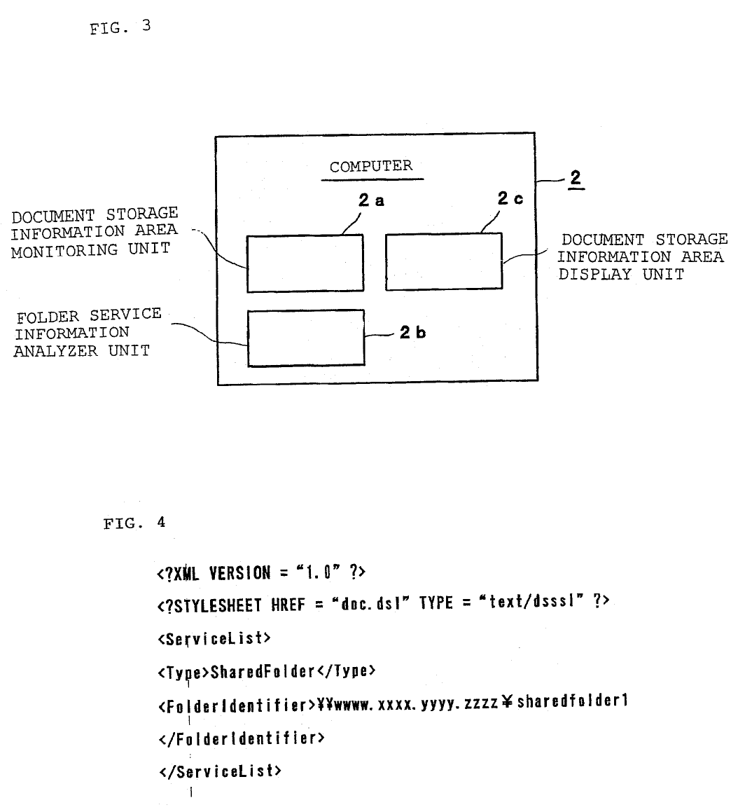

FIG. 2 is a block diagram illustrating an internal function of the file information storage devices 1A, 1B and 1C shown in FIG. 1 according to an embodiment 1. In FIG. 2, the file information storage devices 1A, 1B and 1C are generically denoted by reference numeral 1. The file information storage device 1 comprises a document input unit 1a for inputting a document by capturing the document image, a document storage area generator unit 1b serving as a shared folder creator unit that creates a shared folder to enable the document input via the document input unit 1a to be accessed by a computer on the network, a document storage unit 1c for storing the document input via the document input unit 1a in the created shared folder, a document storage area information generator unit 1d serving as a service information generator unit that generates folder service information with an identifier of the file information storage device and a shared folder identifier when the shared folder is created, and a document storage information area notifying unit 1e for providing the folder service information to the network.

FIG. 3 is a block diagram illustrating an internal function of the computers 2A, 2B and 2C shown in FIG. 1 according to the embodiment 1. In FIG. 3, the computers 2A, 2B and 2C are generically denoted by reference numeral 2. The computer 2 comprises a document storage information area monitoring unit 2a for detecting the folder service information provided to the network, a folder service information analyzer unit 2b for analyzing the detected folder service information, and a document storage information area display unit 2c for displaying the analyzed folder service information on a computer screen.

FIG. 4 illustrates one example of the folder service information generated by the document storage area information generator unit 1d in the file information storage device 1 shown in FIG. 2. As shown in FIG. 4, the identifier of the file information storage device 1 may be a network address and name of the device, and the shared folder identifier may be a name of the shared folder, for example. In FIG. 4, the identifier <FolderIdentifier> of the file information storage device 1 is “\\wwww.xxxx.yyyy.zzzz\sharedfolder1” generated by combining the network address “wwww.xxxx.yyyy.zzzz” and the shared folder “sharedfolder1”.

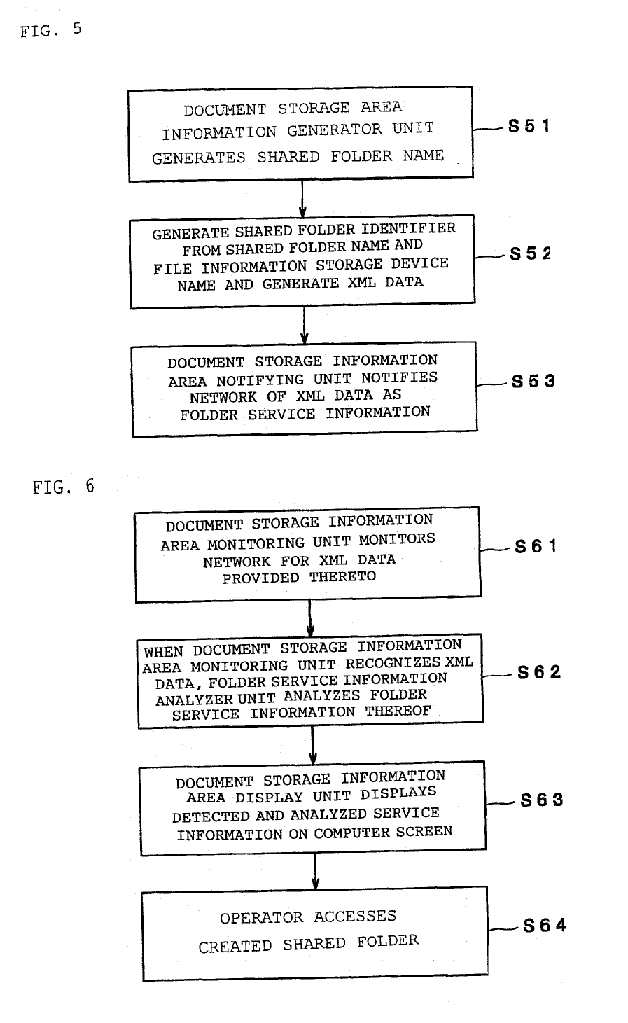

Now, the folder information notifying system and a method therefor according to the embodiment 1 will be described with reference to the flow charts shown in FIGS. 5 and 6. First, a series of processings performed when the shared folder is created in the file information storage device 1 shown in FIG. 2 will be described with reference to the flow chart shown in FIG. 5. In order to create a shared folder for storing a document to be opened to the computer 2 connected to the network, in step S51, the shared folder name “sharedfolder1” is generated in the document storage area information generator unit 1d. Then, in step S52, the shared folder identifier “\\wwww.xxxx.yyyy.zzzz\sharedfolder1” is generated from the shared folder name “sharedfolder1” and the network address “\\wwww.xxxx.yyyy.zzzz” of the file information storage device 1, and XML (extensible markup language) data as shown in FIG. 4 is generated. In step S53, the document storage information area notifying unit 1e notifies the network of the generated XML data as folder service information.

A series of processings for a module in the computer 2 shown in FIG. 2 to detect the XML data, which is the folder service information provided to the network, will be described with reference to the flow chart shown in FIG. 6. In step S61, the document storage information area monitoring unit 2a monitors the network for the XML data provided thereto. In step S62, if the document storage information area monitoring unit 2a recognizes the XML data, the folder service information is analyzed in the folder service information analyzer unit 2b. In step S63, the detected and analyzed service information is displayed on the computer screen by the document storage information area display unit 2c. This display allows the operator to know the creation and location of the shared folder for storing information. Accordingly, instep S64, the operator can access the created shared folder.

Therefore, according to the embodiment 1 described above, when the file information storage device 1 storing document information in a folder, such as a MFP terminal and a file server, is newly installed on the LAN, if the administrator fails to inform the user of the installation or the user fails to receive the information, the computer 2, a user terminal, is notified of the service information when the shared folder is created, and thus, the presence thereof can be automatically known to the user.

Embodiment 2

Now, a folder information notifying system and a method therefor according to an embodiment 2 of this invention will be described. According to the embodiment 2, the system is configured the same as the system shown in FIG. 1.

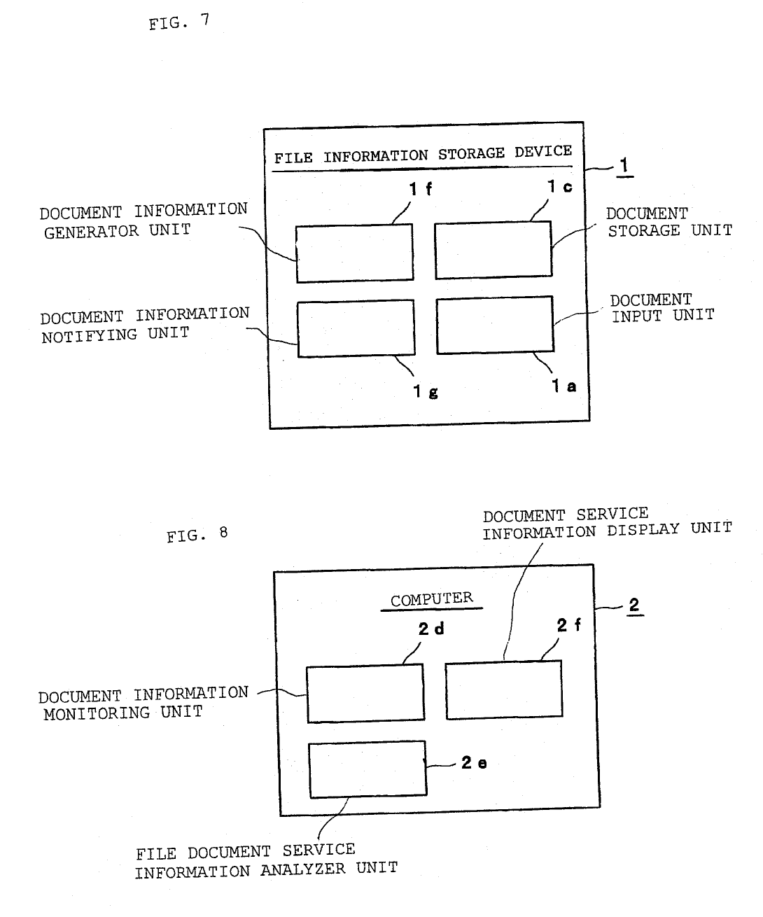

FIG. 7 is a block diagram illustrating an internal configuration of the file information storage devices 1A, 1B and 1C shown in FIG. 1 according to the embodiment 2. The file information storage device 1 shown in FIG. 7 comprises a document input unit 1a for inputting a document by capturing the document image, a document storage unit 1c for storing the document input via the document input unit 1a in a shared folder that can be accessed by a computer 2 on a network, a document information generator unit 1f serving as a service information generator unit that generates document service information including an identifier of the file information storage device, an identifier of the folder in which the document is stored and a name of the stored document when the file document is stored in the shared folder, and a document information notifying unit 1g for providing the generated document service information to the network.

FIG. 8 is a block diagram illustrating an internal configuration of the computers 2A, 2B and 2C shown in FIG. 1 according to the embodiment 2. In FIG. 8, the computer 2 comprises a document information monitoring unit 2d for detecting the file document service information provided to the network, a file document service information analyzer unit 2e for analyzing the detected information, and a document service information display unit 2f for displaying the analyzed document service information on a computer screen.

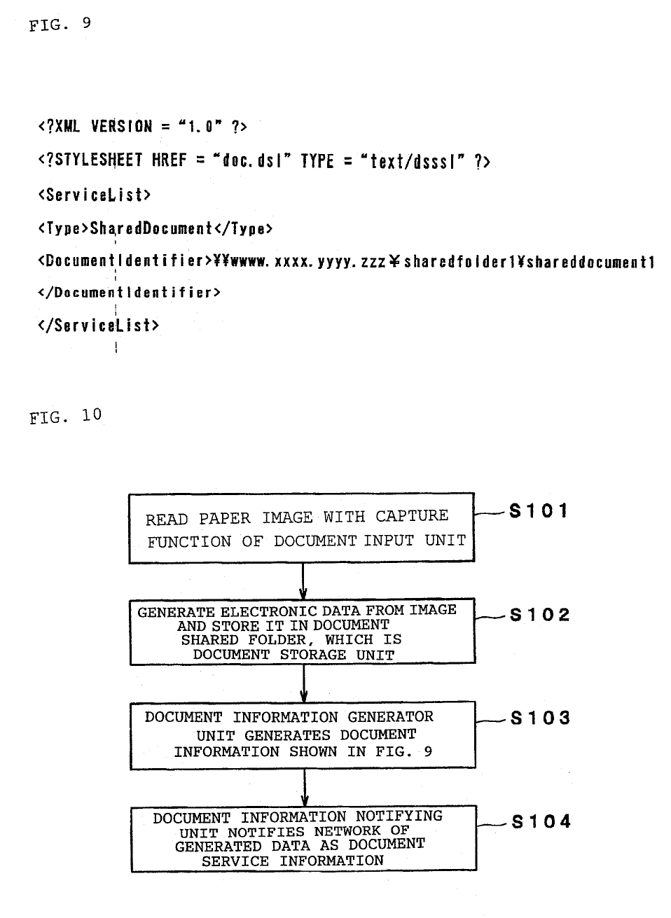

FIG. 9 illustrates one example of the document service information generated by the document information generator unit 1f in the file information storage device 1 shown in FIG. 7. As shown in FIG. 9, the identifier of the file information storage device is the network address of the device described as “wwww.xxxx.yyyy.zzzz”, the shared folder identifier is the name of the shared folder described as “sharedfolder1”, and the document name is described as “shareddocument1”. These are combined to generate “\\wwww.xxxx.yyyy.zzzz\sharedfolder1\shareddocument1”, which describes the value of the tag <DocumentIdentifier> representing the document.

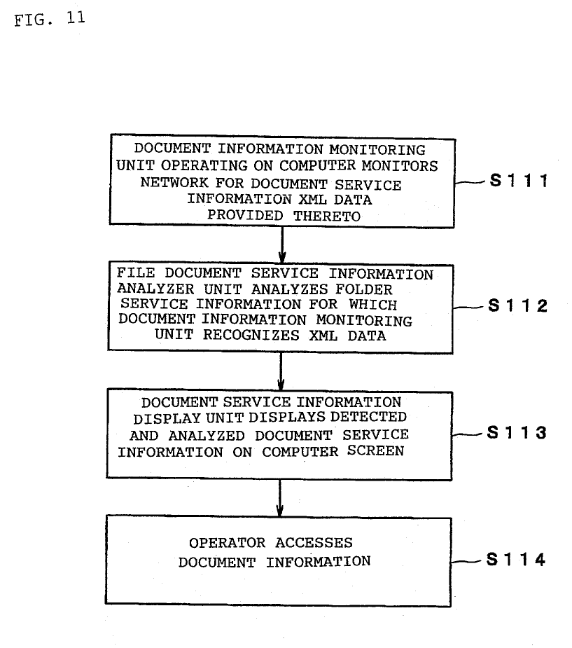

Now, the folder information notifying system and the method therefor according to the embodiment 2 will be described with reference to the flow charts shown in FIGS. 10 and 11. First, a series of processings performed when the file information storage device 1 shown in FIG. 7 stores a document in the shared folder will be described with reference to the flow chart shown in FIG. 10. In order to create a document to be opened to the computer 2 connected to the network, in step S101, the document input unit 1a having a capture function or the like reads a paper image. In step S102, electronic data is generated from the read-in image and stored in the document shared folder named “sharedfolder1” in the document storage unit 1c under the electronic data name of “shareddocument1”. In step S103, the document information generator unit 1f generates the shared folder identifier “\\wwww.xxxx.yyyy.zzzz\sharedfolder1\shareddocument1” from the shared folder name “\sharedfolder1”, the electronic data name “shareddocument1” and the network address of the file information storage device “\\wwww.xxxx.yyyy.zzzz”, and generates XML data as shown in FIG. 9 using the shared folder identifier as the tag <DocumentIdentifier> representing the document. In step S104, the document information notifying unit 1g notifies the network of the generated XML data as document service information.

A series of processings for a module in the computer 2 shown in FIG. 8 to detect the XML data, which is the document service information provided to the network, will be described with reference to the flow chart shown in FIG. 11. In step S111, the document information monitoring unit 2d operating on the computer 2 monitors the network for the document service information XML data provided thereto. In step S112, if the document information monitoring unit 2d recognizes the XML data, the folder service information is analyzed in the file document service information analyzer unit 2e. In step S113, the detected and analyzed document service information “\\wwww.xxxx.yyyy.zzzz\sharedfolder1\shareddocument1” is displayed on the computer screen by the document service information display unit 2f. This display allows the operator to know the presence and location of the document newly stored in the shared folder. Accordingly, in step S114, the operator can access the document information.

Thus, according to the embodiment 2, the computer 2 serving as the user terminal is notified of the service information with the document name stored in the shared folder. Therefore, it is possible to save the user terminal on the LAN from having to retrieve a concerned document.

As described above, according to the embodiments of this invention, when the file information storage device 1 storing document information in a folder, such as a MFP terminal and a file server, is newly installed on the LAN, if the administrator fails to inform the user of the installation or the user fails to receive the information, the user terminal is notified of the service information when the shared folder is created, and thus, the presence thereof can be automatically known to the user.

Furthermore, the user terminal is notified of the service information with the document name stored in the shared folder, and therefore, it is possible to save the user terminal on the LAN from having to retrieve a concerned document.

What is claimed is:

1. A folder information notifying system, comprising:
a plurality of file information storage devices for storing a document interconnected via a network; and
a plurality of user terminals that are interconnected via said network and accessible to a file document stored in a folder in said file information storage devices,
wherein each of said file information storage device comprises:
a shared folder creator unit for creating a shared folder;
a service information generator unit for generating service information from an identifier of the created shared folder and an identifier of the file information storage device; and
a notifying unit for notifying said network of said service information, and
each of said user terminals comprises:
a service information analyzer unit for analyzing the service information provided to said network; and
a display unit for displaying the analyzed service information.

2. The folder information notifying system according to claim 1, wherein when a document to be opened is stored in said shared folder, the service information generator unit in said file information storage device generates said service information with a document name stored in said shared folder in addition to the identifier of the shared folder and the identifier of the file information storage device.

3. A folder information notifying method for notifying a user terminal of folder information, used in a system comprising a plurality of file information storage devices for storing a document interconnected via a network and a plurality of user terminals that are interconnected via said network and accessible to a file document stored in a folder in said file information storage devices, comprising:
the steps on the side of said file information storage device including:
a shared folder creating step of creating a shared folder;
a service information generating step of generating service information from an identifier of the created shared folder and an identifier of the file information storage device; and
a notifying step of notifying said network of said service information, and
the steps on the side of said user terminals including:
a service information analyzing step of analyzing the service information provided to said network; and
a displaying step of displaying the analyzed service information.

4. The folder information notifying method according to claim 3, wherein the service information generating step on the side of said file information storage device is to generate, when a document to be opened is stored in said shared folder, said service information with a document name stored in said shared folder in addition to the identifier of the shared folder and the identifier of the file information storage device.
